(19) United States
(12) Patent Application Publication
(10) Pub. No.: US 2011/0072246 A1
(43) Pub. Date: Mar. 24, 2011

(54) NODE CONTROL DEVICE INTERPOSED BETWEEN PROCESSOR NODE AND IO NODE IN INFORMATION PROCESSING SYSTEM

(76) Inventor: YOSHIHISA YAMADA, Kofu-shi (JP)

(21) Appl. No.: 12/885,843

(22) Filed: Sep. 20, 2010

(30) Foreign Application Priority Data
Sep. 24, 2009 (JP) P2009-219093

(51) Int. Cl. G06F 9/30

(52) U.S. Cl. 712/220; 712/E09.016

(57) ABSTRACT

A node control device is interposed between processor nodes and IO nodes in an information processing system, wherein each IO node subordinates at least one IO device. The node control device includes a register storing a base address of a mapping destination of an IO space, a table describing a plurality of entries retaining a plurality of IO space numbers and address ranges, and an IO space access detection circuit. The table stores an identification flag as to whether or not IO spaces are each mapped onto a memory space. The IO space access detection circuit decodes a command code and an address of an FRTT signal output from a processor node, thus detecting a target IO space and detecting whether the processor node is accessing an IO space mapped onto the memory space or another IO space.

The present application claims priority on Japanese Patent Application No. 2009-219093, the content of which is incorporated herein by reference.

### BACKGROUND OF THE INVENTION

1. Field of the Invention

The present invention relates to large-scale information processing systems including IO nodes handling IO spaces based on PCT standards, and in particular to node control devices interposed between processor nodes and ID nodes.

2. Description of the Related Art

Large-scale information processing systems including IO nodes (or input/output devices) need to be connected with all input/output devices (or IO devices) using IO spaces; but this causes a shortage of IO spaces (e.g. data buffers). This is a crucial problem needed to be solved.

When the number of input/output devices controlled by a single processor node increases, it is necessary to use a large storage capacity (i.e. a large IO space) accommodating those input/output devices. PCI standards (where “PCI” stands for “Peripheral Component Interface”) such as PCI-Express define only 64 KB for IO spaces assigned to all input/output devices. This has motivated the present inventor to develop an information processing system in which a single processor node is able to handle a plurality of IO spaces which are needed to establish connections with numerous IO devices.

Recently, a new type of interface handling a plurality of IO spaces has been developed and applied between the latest operating system (OS) and the system firmware. However, no technology for recognizing and handling a plurality of IO spaces has been developed with respect to LSI devices for controlling general-purpose input/output devices. A certain type of the existing OS is unable to handle a plurality of IO spaces. Similarly, no technology for recognizing and handling a plurality of IO spaces has been developed with respect to existing LIS devices at IO nodes.

One pioneering technology in this field is Patent Document 1 which discloses a distributed multi-node computer system including CPU nodes, IO nodes, and memory nodes which are connected together via interconnections. This computer system is divided into a plurality of domains, each of which serves as an independent machine having its unique address space, wherein each operating system independently runs on each domain.

Patent Document 2 discloses a computer system which executes a LPAR control program (where “LPAR” stands for “Logical Partition”) to implement virtual mapping on a memory space and an IO space of a single physical device with respect to each OS. The LPAR program divides a single computer system into a plurality of logical partitions (LPAR), each of which is assigned with a LPAR identifier (which identifies each LPAR).

Patent Document 3 discloses a node control device in which base addresses and sizes of configuration spaces are set to two registers, thus mapping a plurality of configuration spaces into a memory space. A configuration access detection circuit outputs an index signal included in an FRTT signal (where “FRTT” stands for “Fixed Round-Trip Time”), which merges a bus number of a bus connected with an accessed device and a segment number of a configuration space assigned to an IO node subordinating the bus thereto. This node control device is equipped with a table which is able to output a node ID of an IO node stored in an entry corresponding to an index signal and a crossbar switch which implements routing of an FRTT signal to an IO node having a designated node ID.

Patent Document 4 disclose an IO mapping method of a system bus, which cancels a limitation on an available capacity of an IO space so as to secure connectivity with devices needing a large-scale IO space and which aims at reducing the size of the overall circuitry. Specifically, an adaptor connected to a system bus is constituted of a base address register for setting a value defining an IO address space, a comparator which compares the value of the base address register with an address sent onto the system bus and which, when they match each other, responds to the system bus while activating a select signal, and a decoder which inputs the address of the system bus and the select signal and which performs mapping on devices while avoiding an aliasing space, thus producing a device select signal.

Conventionally-known information processing systems employ PCI standards such as PCI-Express, which limit an IO space having a 64 KB capacity designated using a 16-bit address. Large-scale information processing systems including a plurality of IO nodes need to establish connections with numerous IO devices. Since those IO devices intensively use IO spaces, they suffer from a shortage of IO spaces.

The aforementioned technologies disclosed in Patent Document 1 through Patent Document 4 are not designed in light of compatibility with existing control systems each handling a single IO space. The technology of Patent Document 1 does not adopt a node control device, although the operating system (OS) having a plurality of CPUs achieves the functionality of a node control device.

In Patent Document 2, the computer system executes the LPAR control program so as to achieve the functionality of a node control device. The node control device of Patent Document 3 is designed to handle a memory space mapping a plurality of configuration spaces, which is different from an IO space. This node control device is characterized by using two registers.

The technology of Patent Document 4 aims at securing connectivity with devices needing a large-scale IO space but does not achieve connectivity with numerous IO devices in which each IO node is able to handle a plurality of IO spaces.
Patent Document 1: Japanese Patent Application Publication No. 2003-132037
Patent Document 2: Japanese Patent Application Publication No. 2008-158710
Patent Document 3: Japanese Patent Application Publication No. 2008-181389
Patent Document 4: Japanese Patent Application Publication No. H11-238029

### SUMMARY OF THE INVENTION

The present invention seeks to solve the above problems, or to improve upon those problems at least in part.

It is an object of the present invention to provide a node control device interposed between processor nodes and IO nodes. Specifically, the node control device of the present invention implements a function of mapping a plurality of IO spaces in a memory space in advance, a function of decoding numbers of IO spaces based on addresses, and a function of routing accesses to corresponding IO nodes. Each IO node is able to handle a plurality of IO spaces so as to secure connectivity with numerous IO devices.

It is another object of the present invention to provide a control method of the node control device, an information processing system using the node control device, and a computer program.

A node control device of the present invention is adapted to an information processing system including a plurality of processor nodes and a plurality of IO nodes having IO spaces, each of which stores attribute information with respect to at least one IO device. The node control device interposed between processor nodes and IO nodes is constituted of a table describing a plurality of entries retaining the attribute information with respect to IO spaces in connection with IO devices and an IO space access detection circuit which compares an instruction signal of a processor node with the attribute information of each of the entries described in the table so as to detect a designated IO node and a designated IO device.

The instruction signal of a processor node is an FRTT signal having a header FRTT format including a command code, a target node ID, a source node ID, and an address, so that the IO space access detection circuit checks whether or not the address of an FRTT signal falls within an address range between an upper-limit address and a lower-limit address which are preset with respect to each of the entries of the table.

A node control method of the present invention is implemented via a step of describing a plurality of entries retaining the attribute information with respect to the IO spaces in connection with the IO devices in advance, a step of comparing an instruction signal of a processor node with the attribute information of each of the entries, and detecting a designated IO node and a designated IO device based on the entry which matches the instruction signal of a processor node.

An information processing system of the present invention is constituted of a plurality of processor nodes, a plurality of IO nodes, and a node control device interposed between processor nodes and IO nodes.

A computer program of the present invention is loaded into a computer so as to execute a node control method adapted to an information processing system.

The present invention allows different types of operating systems (OS) to be independently executed on the information processing system via the node control device, wherein one OS is able to handle a plurality of IO spaces while the other OS is able to handle a single IO space.

### BRIEF DESCRIPTION OF THE DRAWINGS

These and other objects, aspects, and embodiments of the present invention will be described in more detail with reference to the following drawings.

FIG. 1 is a block diagram showing the overall configuration of an information processing system according to an embodiment of the present invention.

FIG. 2 is a block diagram showing an internal configuration of an IO node included in the information processing system of FIG. 1.

FIG. 3 is a block diagram showing an internal configuration of a node control device included in the information processing system of FIG. 1.

FIG. 4 is a block diagram showing an internal configuration of an input port included in the node control device shown in FIG. 3.

FIG. 5 shows a data configuration format of a table included in the input port shown in FIG. 4.

FIG. 6 shows a data configuration format of mapping an IO space onto a memory space.

FIG. 7A shows a transfer format for transferring a header FRTT in the information processing system.

FIG. 7B shows a transfer format for transferring a data FRTT in the information processing system.

FIG. 8A shows an address format for accessing an IO space mapped onto a memory space.

FIG. 8B shows an address format for accessing an existing IO space.

FIG. 9 is a flow chart showing a procedure of an IO space access detection circuit, included in the input port shown in FIG. 4, which produces a coincident signal and a node ID signal in accordance with a command from a processor node.

FIG. 10 is a block diagram of the information processing system divided into a plurality of partitions.

### DESCRIPTION OF THE PREFERRED EMBODIMENT

The present invention will be described in further detail by way of examples with reference to the accompanying drawings.

The present invention is directed to a large-scale information processing system including a plurality of IO nodes in which at least one node control device is able to handle a plurality of IO spaces (each of which is regarded as an input/output device control area including a data buffer), thus establishing connectivity with a plurality of IO devices needing numerous IO spaces.

The present invention is applicable to existing processors in which all IO devices are assigned to a single IO space; hence, the present invention is compatible to existing information processing devices whose operating systems (OS) are unable to recognize a plurality of IO spaces.

An information processing system can be divided into a plurality of partitions allowing a plurality of operating systems to run. In this case, the present invention allows the user (or operator) to select either a single IO mode which allows for a single IO space or a multiple-IO mode which allows for a plurality of IO spaces.

To meet a requirement of establishing connectivity with numerous IO devices via IO spaces, the present invention needs to facilitate at least one node control device controlled with the system firmware or a service processor, thus allowing a single processor to utilize a plurality of IO spaces.

Next, an embodiment of the present invention will be described with respect to a node control device and its control method, as well as an information processing system.

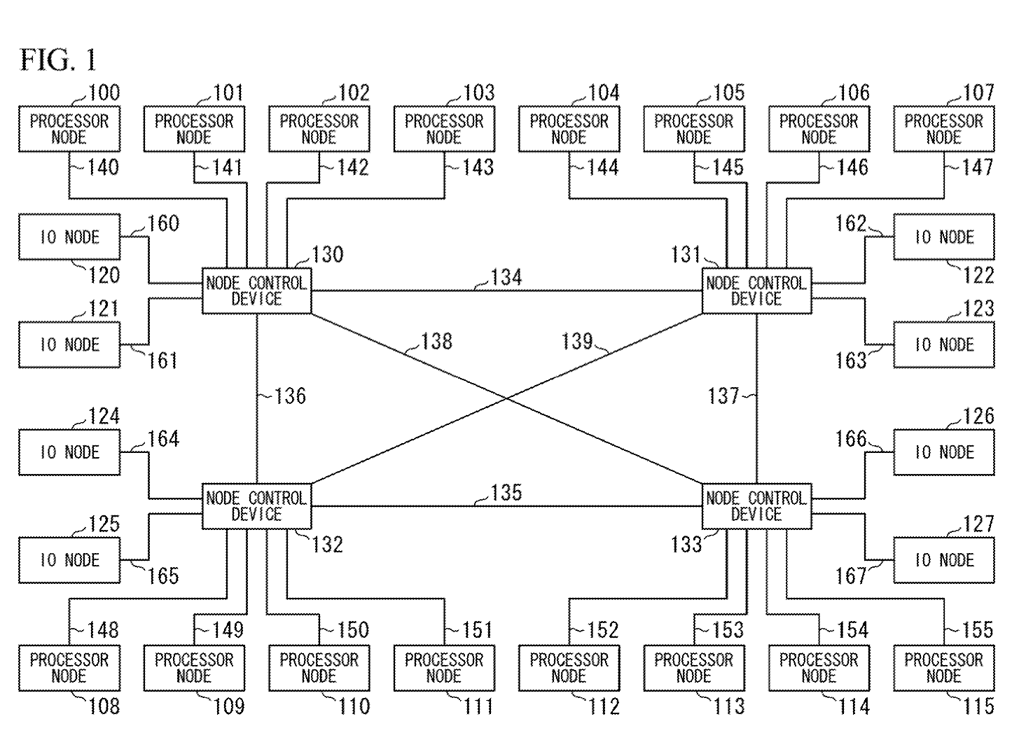

FIG. 1 is a block diagram showing the overall configuration of an information processing system according to an embodiment of the present invention. The information processing system of the present embodiment includes sixteen processor nodes 100 through 115, eight IO nodes 120 through 127, and four node control devices 130 through 133.

Among the node control devices 130-133, each node control device is coupled with two IO nodes within the IO nodes 120-127, as well as four processor nodes within the processor nodes 100-115. The node control devices 130-133 are mutually connected in a one-to-one manner. Each processor node includes a single processor or a plurality of processors together with a main memory.

The information processing system is not necessarily limited to the configuration of FIG. 1; hence, it is possible to adopt a small-scale configuration including two processor nodes, one node control device, and two IO nodes or a large-scale configuration including sixty-four processor nodes, thirty-two IO nodes, and sixteen node control devices.

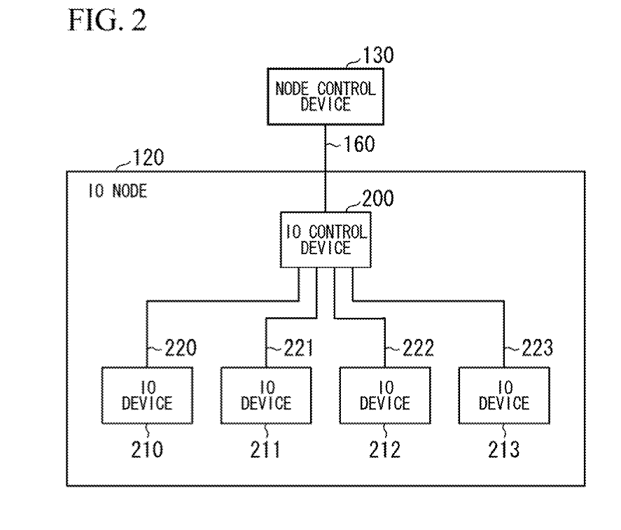

FIG. 2 is a block diagram showing an internal configuration of the IO node 120 (representing the IO nodes 120-127), which is constituted of an IO control device 200 and four IO devices 210 through 213.

The IO control device 200 is connected to the node control device 130 via an interface 160. In addition, the IO control device is connected to the IO devices 210 through 213 via interfaces 220 through 223 based on a PCT standard such as PCI-Express. The IO node is not necessarily limited to the configuration of FIG. 2; hence, it is possible to adopt another configuration including a small number of IO devices or a large number of IO devices.

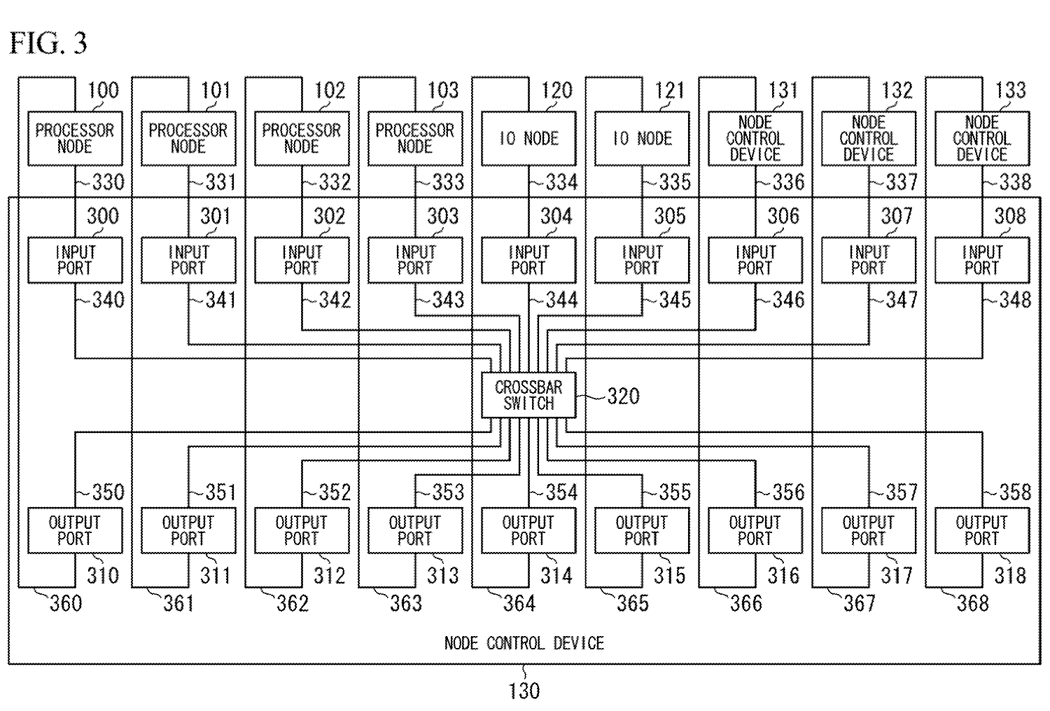

FIG. 3 is a block diagram showing an internal configuration of the node control device 130 (representing the node control devices 130-133). The node control device 130 of FIG. 3 is constituted of nine input ports 300 through 308, nine output ports 310 through 318, and a crossbar switch 320. In this connection, a pair of an input port and an output port is defined as a single port. For example, a port coupled with the processor node 100 is constituted of the input port 300 and the output port 310. That is, nine ports of the node control device 130 are arranged to establish connections with the processor nodes 100-103, the IO nodes 120-121, and the node control devices 131-133 respectively.

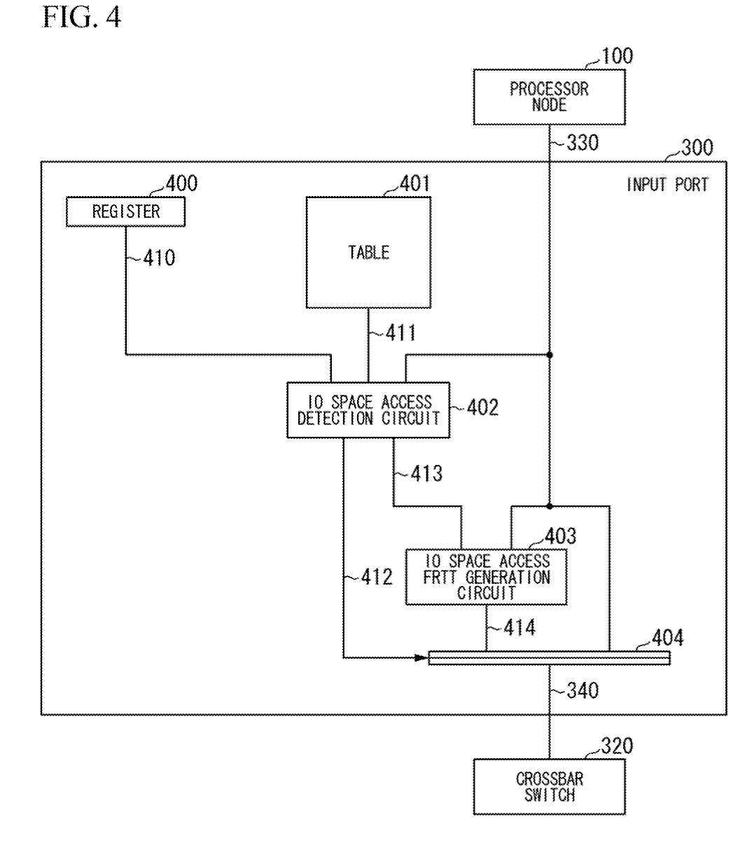

FIG. 4 is a block diagram showing an internal configuration of the input port 300 (representing the input ports 300-308) in the node control device 130. A register 400 is a 16-bit register retaining a value designating a base address of an IO space mapping onto a memory space. Herein, bit 15 through bit 0 of the register 400 correspond to bit 47 through bit 32 of a base address, wherein bit 31 through bit 0 of the base address are all set to zero.

A table 401 is a register having entries each corresponding to each IO node and retaining a value designating a range of an IO space assigned to an IO device of each IO node. Since the present embodiment has eight IO nodes, the table 401 has eight entries.

Next, a concrete solution to the foregoing problem will be described with reference to FIG. 4.

A base address of a memory space, which is a destination of mapping with respect to an IO space, is set to the register 400. The table 401 has entries, the number of which corresponds to the number of IO nodes included in the information processing system. The table 401 stores an IO space number and an address range, which designate an IO space assigned to IO devices of each IO node.

The table 401 further stores an identification flag indicating whether or not an IO space assigned to each IO device of each IO node is an IO space mapping onto a memory space.

An IO space access detection circuit 402 decodes a command code and an address of an FRTT signal 330 (e.g. input/output information) output from a corresponding processor node. The IO space access detection circuit 402 detects an access to an IO space and a node ID of a target IO node.

Upon detecting an access to an IO space mapping onto a memory space, an IO space access FRTT generation circuit 403 and a selector 404 converts such an access into an IO space access processable with an IO node. The IO space access FRTT generation circuit 403 and the selector 404 designates a node ID of a target IO node so as to output it to the crossbar switch 320.

As described above, the node control device of the present embodiment having a function of mapping a plurality of IO spaces onto a memory space recognizes an IO space number upon detecting an access to a mapped IO space so as to output the IO space number to a target IO node. This makes it possible to handle a plurality of IO spaces; hence, the node control device of the present embodiment allows a single processor node to be connected with numerous IO devices in comparison with conventional node control devices. Owing to an identification flag indicating whether an IO space assigned to an IO device of each IO node is an IO space mapping onto a memory space or an IO space of an existing node control device, the present embodiment is applicable to an existing OS which is unable to handle a plurality of IO spaces.

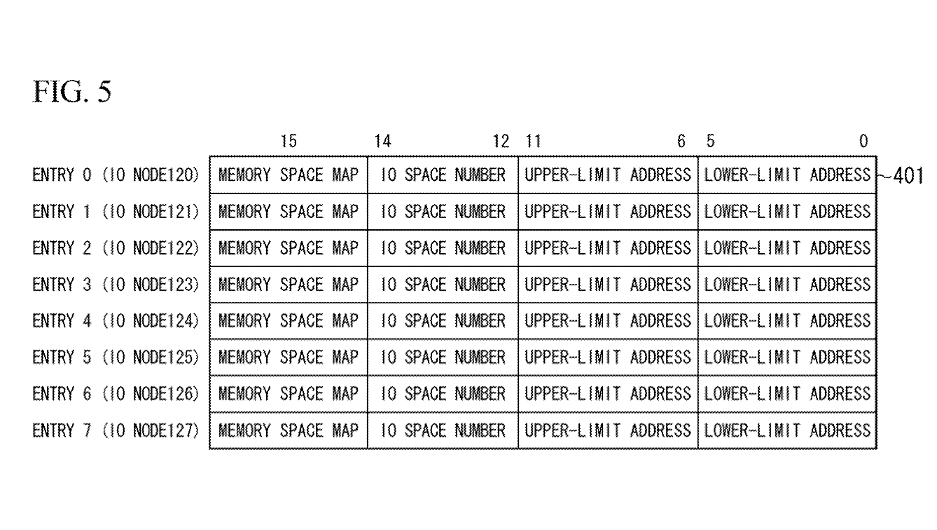

FIG. 5 shows a data configuration format of the table 401. The table 401 contains entry 0 through entry 7 in correspondence with the IO nodes 120 through 127. Bit 15 of each entry is a flag indicating a memory space map, wherein “0” indicates a conventional IO space while “1” indicates an IO space mapping onto a memory space. Bit 14 through bit 12 denote an IO space number of an IO space mapping onto a memory space. Bit 11 through bit 6 denote an upper-limit address whilst bit 5 through bit 0 denote a lower-limit address in correspondence with bit 15 through bit IO of an address of an IO space, thus indicating an address range of an IO space. Bit 9 through bit 0 of an upper-limit address of an address range are all set to “1” whilst bit 9 through bit 0 of a lower-limit address of an address range are all set to “0”. In the case of a lower-limit address of “000100” and an upper-limit address of “000111” in a binary notation, an address range is expressed as “1000” through “1FFF” in a hexadecimal notation.

The contents of the register 400 and the table 401 are set up by the system firmware or a service processor at an initialization mode. The details of the setup operation are well known by person having ordinary skill in the art and irrelevant to the present invention; hence, an explanation thereof will be omitted.

Upon inputting a header FRTT (whose strobe field is “01” in a decimal notation) as the FRTT signal 330 from the processor node 100, the IO space access detection circuit 402 compares a command field and an address field of the header FRTT to values retained in the register 400 and the table 401 so as to produce a coincidence signal 412 and a node ID signal 413.

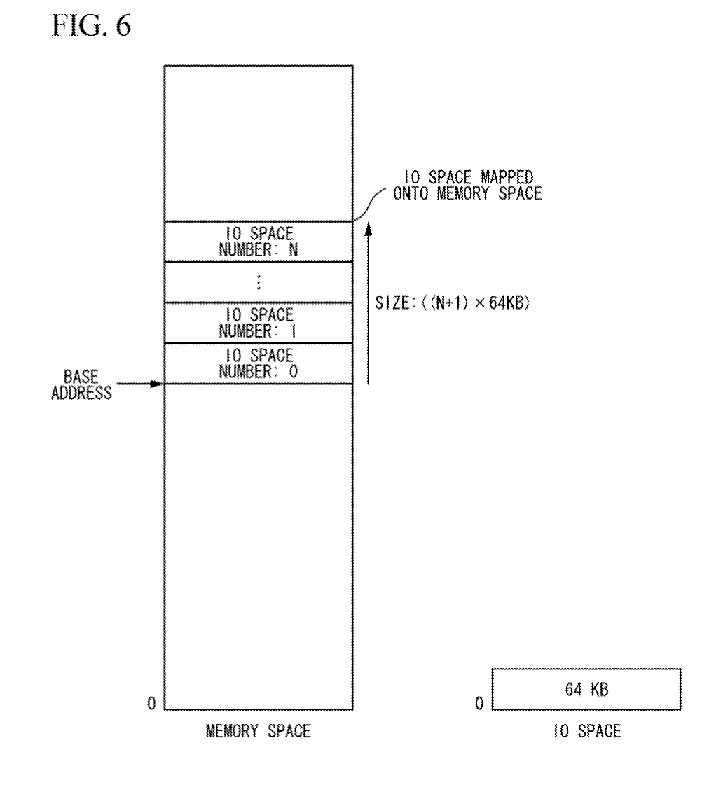

Next, a mapping method for mapping an IO space onto a memory space will be described. FIG. 6 shows a data configuration format of mapping an IO space onto a memory space.

A single IO space has a capacity of 64 KB; hence, a plurality of IO spaces is consecutively mapped onto a certain area of an address space. In FIG. 6, N+1 IO spaces are mapped onto an area ranging from a base address to “a base address plus size minus 1”. Herein, the size is (N+1)×64 KB, and IO spaces are identified using IO space numbers 0 through N.

The present embodiment is designed based on the “Dense Translation” method in the ACPI specification (where “ACPI” stands for “Advanced Configuration and Power Interface”) as a mapping method for mapping a plurality of IO spaces onto a memory space, but the present embodiment is applicable to the “Sparse Translation” method. It is possible to simultaneously adopt both methods by adding an identification flag to the table 401.

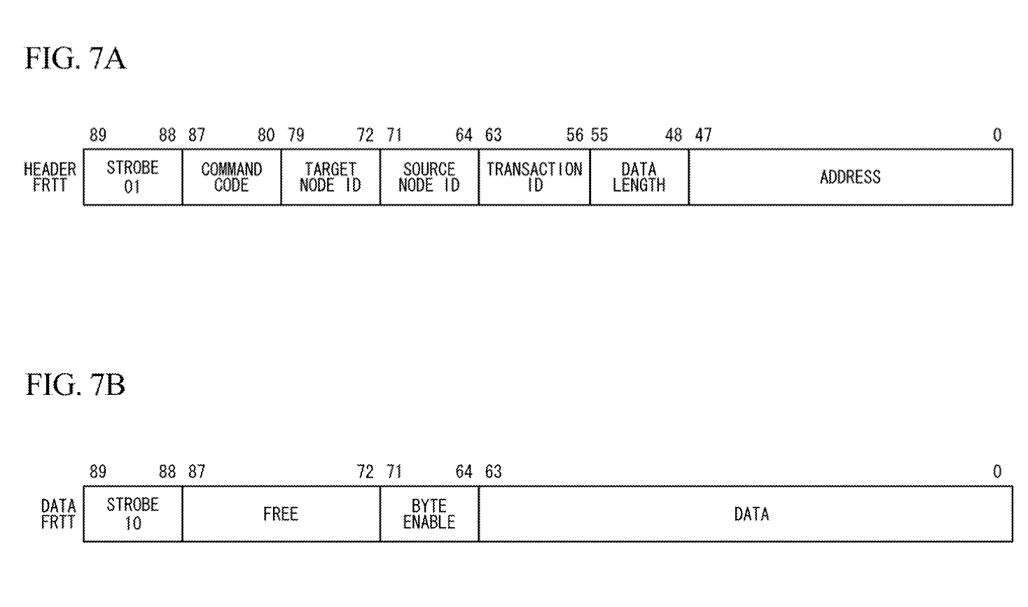

FIGS. 7A and 7B show transfer formats for transferring FRTT data in the information processing system. The present embodiment employs packets as logical units for transferring information, wherein each packet is configured of one or more FRTT. Each FRTT shown in FIGS. 7A and 7B has a fixed number of bits, e.g. ninety bits. There are two types of FRTT, namely a header FRTT and a data FRTT which are transferred via the transfer formats shown in FIGS. 7A and 7B.

Bit 89 and bit 88 of each FRTT denote a strobe indicating whether or not each FRTT is valid and a type of each FRIT. Specifically, a strobe of “00” in a binary notation indicates that each FRTT is invalid; “01” indicates a header FRTT; and “10” indicates a data FRIT. These binary values are mere examples. In this connection, each packet includes one header FRTT accompanied with zero data FRTT, one data FRTT, two data FRTT, four data FRTT, or eight data FRTT. That is, the minimum size of each packet is configured of one FRTT (i.e. one header FRTT) whilst the maximum size of each packet is configured of nine FRTT (i.e. one header FRTT and eight data FRTT).

In general, each FRTT is accompanied with an error correcting code (ECC) or a parity for the purpose of error detection and error correction, which is irrelevant to the present embodiment; hence, an explanation thereof will be omitted.

Bit 87 through bit 0 of the head FRTT includes five 8-bit fields and a 48-bit address field. The definitions of these fields are mere examples, wherein they are determined dependent upon resources, protocols and topologies of information processing devices.

Bit 87 through 80 of the header FRTT denotes a command code, i.e. an 8-bit field for retaining operations on a target node, such as memory read, memory write, IO read, IO write, and reply.

Bit 71 through bit 64 of the header FRTT denote a source node ID, i.e. an 8-bit field for retaining a unique number identifying a source of transferring packets, such as a processor node, an IO node and a node control device.

Bit 79 through bit 72 of the header FRTT denote a target node ID, i.e. an 8-bit field for retaining a unique number identifying a destination of receiving packets, such as a processor node, an IO node and a node control device.

Bit 55 through bit 48 of the header FRTT denote a data length, i.e. an 8-bit field for retaining data lengths of a target node in units of bytes in a read request mode. A data length of “00” through “40” in a hexadecimal notation designates zero byte through sixty four bytes. Other hexadecimal values of the data length are undefined.

Bit 47 through bit 0 of the header FRTT denote an address, i.e. an 8-bit field for retaining an address of a target node upon request.

Bit 71 through bit 64 of the data FRTT denote a byte enable, indicating whether each byte of data stored in an area of bit 63 through bit 0 is valid or invalid.

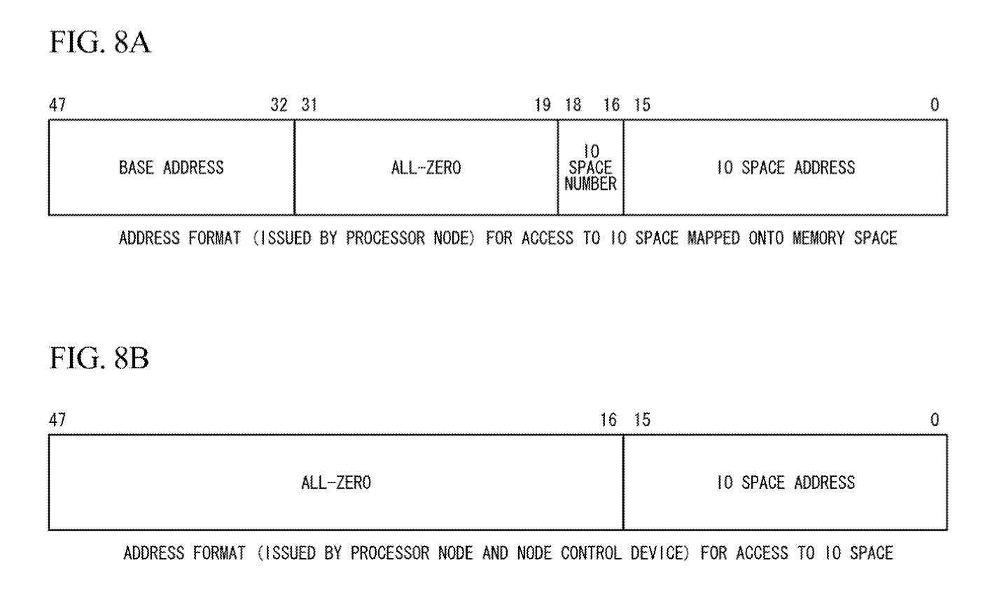

FIGS. 8A and 8B show data configurations for accessing IO spaces in the address field of the header FRTT shown in FIG. 7A. FIG. 8A shows an address format (issued by the processor node) for accessing an IO spaced mapped onto a memory space whilst FIG. 8B shows a conventional address format (issued by the processor node and the node control device) for accessing an IO space.

In the address format of FIG. 8A according to the present invention, which is used to make an access to an IO space mapped onto a memory space, bit 47 through bit 32 denote a base address of the memory space mapping the IO space. The base address can designate a 4-Giga byte boundary address; but it is possible to designate another address with a fine granularity. For example, the base address can be resided in bit 47 through bit 20 and designated using a 1-Mega byte address. Bit 31 through bit 19 are free and all set to zero.

Bit 18 through bit 16 of the address format of FIG. 8A denote an IO space number consisting of three bits, which represents a decimal number ranging from “0” to “7”.

To cope with numerous IO nodes involved in the information processing system, it is possible to increase the range of the IO space number. For example, bit 23 through bit 16 can be used to store an IO space number consisting of eight bits, which represents a decimal number ranging from “0” to “255”. Bit 15 through bit 0 denote an IO space address.

In the conventional address format of FIG. 8B for accessing an IO space, bit 47 through bit 16 are free and all set to zero whilst bit 15 through bit 0 denote an IO space address.

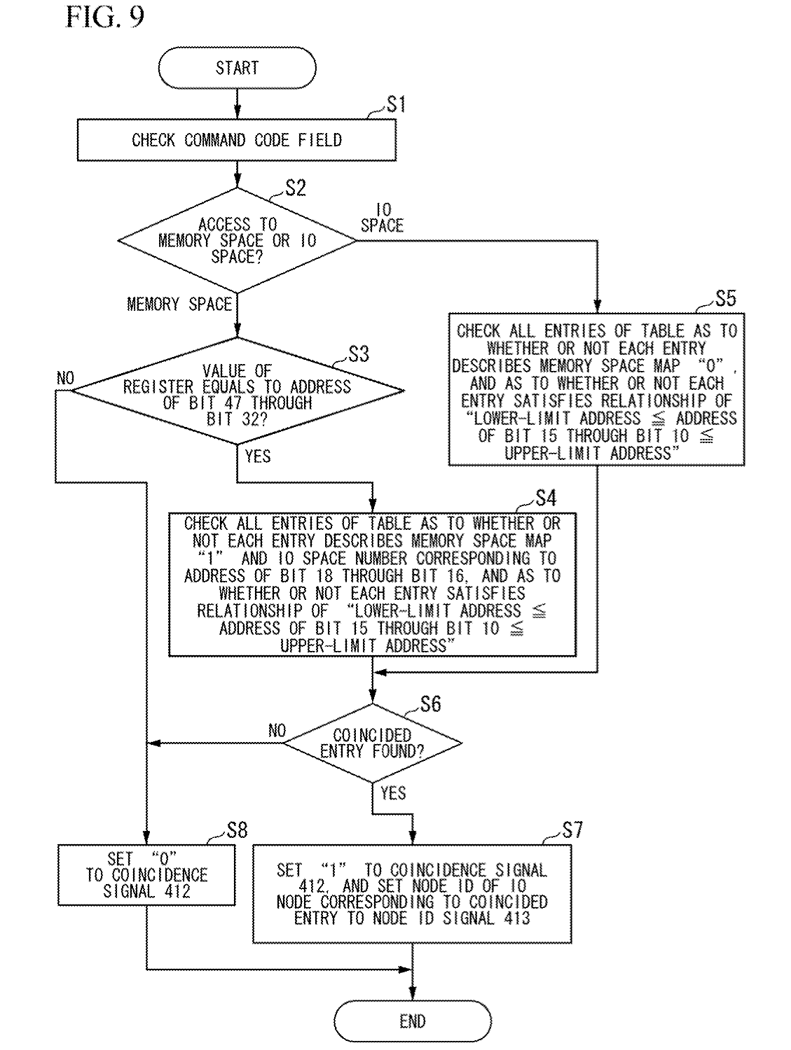

FIG. 9 is a flowchart showing a procedure of the IO space access detection circuit 402 that produces the coincidence signal 412 and the node ID signal 413.

Next, a procedure for producing the coincidence signal 412 and the node ID signal 413 will be described with reference to FIGS. 4 and 5, FIGS. 7A and 7B, FIGS. 8A and 8B, and FIG. 9.

This procedure is implemented by the system firmware in the IO space access detection circuit 402.

(Step S1)

In step S1, the IO space access detection circuit 402 verifies a command code field of a command (not shown) output from the processor node 100.

(Step S2)

In step S2, the IO space access detection circuit 402 discriminates the verification result on the command code field. When the command code field indicates an access to a memory space (e.g. a memory read operation or a memory write operation), the flow proceeds to step S3. When the command code field indicates an access to an IO space (e.g. an IO read operation or an IO write operation), the flow proceeds to step S5.

(Step S3)

In step S3, the IO space access detection circuit 402 verifies whether or not the value of the register 400 is equal to the value retained in the address of bit 47 through bit 32. When the value of the register 400 is equal to the value retained in the address of bit 47 through bit 32, the flow proceeds to step S4. When the value of the register 400 is not equal to the value retained in the address of bit 47 through bit 32, the flow proceeds to step S5.

(Step S4)

In step S4, the IO space access detection circuit 402 checks all entries of the table 402, as to whether or not each entry describes the memory space map “1” and the IO space number corresponding to the value retained in the address of bit 18 through bit 16 and as to whether or not each entry is ascribed to the relationship of “(lower-limit address)≦(value retained in address of bit 15 through bit 10)≦(upper-limit address)”. After completion of step S4, the flow proceeds to step S6.

(Step S5)

In step S5, the IO space access detection circuit 402 checks all entries of the table 402, as to whether or not each entry describes the memory space map “0” and as to whether or not each entry is ascribed to the relationship of “(lower-limit address)≦(value retained in address of bit 15 through bit 10)≦(upper-limit address)”. After completion of step S5, the flow proceeds to step S6.

(Step S6)

In step S6, the IO space access detection circuit 402 verifies whether or not the table 401 includes an entry satisfying the foregoing conditions described in the command code field. When the table 401 includes an entry satisfying the foregoing conditions of the command code field, the flow proceeds to step S7. When no entry satisfying the foregoing conditions of the command code field is found in the table 401, the flow proceeds to step S8.

(Step S7)

In step S7, the IO space access detection circuit 402 sets the coincidence signal 412 to “1” while outputting the node ID signal 413 having a node ID of an IO node corresponding to a coincided entry.

(Step S8)

In step S8, the IO space access detection circuit 402 sets the coincidence signal 412 to “0”.

After completion of step S7 or step S8, the IO space access detection circuit 402 exits the procedure of FIG. 9.

When the processor node 100 outputs the FRTT signal 330 representing a header FRTT, the IO space access FRTT generation circuit 403 changes all of bit 47 through bit 16 of the address field into zeros while changing the target node ID with the node ID signal 413 from the IO space access detection circuit 402. In addition, the IO space access FRTT generation circuit 403 changes the command code from a memory read code to an IO read code while changing the command code from a memory write code to an IO write code. Subsequently, the IO space access FRTT generation circuit 403 outputs a header FRTT signal 414 reflecting the above changes to the selector 404.

The selector 404 selects the FRTT signal 330 when the coincidence signal 412 is “0”. Alternatively, the selector 404 selects the header FRTT signal 414 when the coincidence signal 412 is “1”. Thus, the selector 404 outputs the FRTT signal 330 or the header FRTT signal 414 to the crossbar switch 320.

Next, the functionality of the information processing system of the present embodiment will be described in detail.

### (1) First Operation

A first operation is an operation of the node control device 130 whose input port 300 handles a plurality of IO spaces mapped onto a memory space.

An initialization is performed on the information processing system as follows:

The system firmware of the IO space access detection circuit 402 assigns IO space numbers and address ranges of IO spaces with respect to the IO nodes 120 through 127. For example, IO space numbers “0” through “7” are assigned to the IO nodes 120 through 127. An address range of “0000” through “7FFF” in a hexadecimal notation is assigned to the IO node 120, while an address range of “8000” through “FFFF” in a hexadecimal notation is assigned to the IO nodes 121 through 127.

Next, the system firmware of the IO space access detection circuit 402 sets up a base address of a memory space used for mapping IO spaces; subsequently, the base address is set to the registers 400 of the input ports 300 through 308 in the node control devices 130 through 133. When the base address is set to “1C0000000000” in a hexadecimal notation, “1C00” is set to the register 400. In addition, the system firmware sets a certain value to the table 401 of the input ports 300 through 308 in the node control devices 300 through 303.

In the table 401, entry 0 describes a memory space map “1”, an IO space number “000”, an upper-limit address “011111”, and a lower-limit address “000000” in binary notation. Entry 1 describes a memory space map “1”, an IO space number “001”, an upper-limit address “111111”, and a lower-limit address “100000” in binary notation. Entries 2 through 7 are identical to entry 1 except for their IO space numbers, which range from “010” to “111” in binary notation. In this connection, a service processor can substitute for the system firmware so as to set up the above values in entries 0 through 7 in the table 401.

Next, the processor node 100 performs an IO read operation on an IO device subordinate to the IO node 124 by use of an IO space address of “8000” in hexadecimal notation.

The processor node 100 issues an FRTT signal 330 having the header FRTT format shown in FIG. 7A, including a strobe of “01” in binary notation, a memory read code as a command code, an node ID of the processor node 100 as a source node ID, a node ID of the node control device 130 as a target node ID, and a length of accessed data as a data length.

A transaction ID is set to a unique number with respect to the processor node 100. An address field of the header FRTT format shown in FIG. 7A is set up in accordance with the address format of FIG. 8A, so that bit 47 through bit 32 denote a base address of “1C00” in hexadecimal notation, bit 31 through bit 19 are all set to zeros, bit 18 through bit 16 denote an IO space number of “100” assigned to the IO node 124 in binary notation, and bit 15 through bit 0 are set to “8000” in hexadecimal notation. That is, the processor node 100 issues a memory read code with respect to an address of “1C0000048000” in hexadecimal notation.

Next, the operation of the IO space access detection circuit 402 using a plurality of IO spaces mapped onto a memory space will be described with reference to the flowchart of FIG. 9.

Upon receiving the FRTT signal 330 from the processor node 100, the IO space access detection circuit 402 discriminates a strobe field of “01” in binary notation indicating a header FRTT; hence, the IO space access detection circuit 402 compares the command code field and the address field with the value of the register 400 and the value of the table 401.

Specifically, the IO space access detection circuit 402 checks the command code field in step S1 and detects a memory read code in step S2, thus detecting an access to the memory space. Thus, the flow proceeds to step S3, in which the IO space access detection circuit 402 compares the value of the register 400 with the address of bit 47 through bit 32, wherein it detects that both values are set to the same hexadecimal value of “1C00”. Subsequently, the flow proceeds to step S4.

In step S4, the IO space access detection circuit 402 detects that the header FRTT describes the memory space map “1”, the IO space number of “100” in binary notation, and the address of bit 15 through bit 30 retaining “100000” in binary notation which falls within the range between the lower-limit address and the upper-limit address, i.e. “100000” through “111111” in binary notation, in connection with entry 4 of the table 401. In step S6, the IO space access detection circuit 402 detects that entry 4 matches the foregoing conditions; hence, the flow proceeds to step S7. In step S7, the IO space access detection circuit 402 outputs the coincidence signal 412 which is set to “1” and the node ID signal 413 which describes the node ID of the IO node 214 corresponding to entry 4 of the table 401. Thereafter, the IO space access detection circuit 402 exits the procedure of FIG. 9.

Upon receiving the FRTT signal 330 having a header FRTT format from the processor node 100, the IO space access FRTT generation circuit 403 modifies the FRTT signal 330 such that bit 47 through bit 32 of the address field are all set to zeros; the target node ID is changed with the node ID signal 413 output from the IO space access detection circuit 402; and the command code is changed from the memory read code to the IO read code, thus generating a header FRTT signal 414.

Owing to the coincidence signal 412 of “1”, the selector 404 selects the header FRTT signal 414 as the FRTT signal 340, which is output to the crossbar switch 320.

The crossbar switch 320 supplies the FRTT signal 340 to the output port 317 in accordance with the target node ID. In this connection, the detailed method for determining a destination of an output port according to the target ID node is irrelevant to the present embodiment; hence, an explanation thereof will be omitted.

The output port 317 sends FRTT data (corresponding to the FRTT signal 340) to the IO node 124 via the node control device 132, so that FRTT data is delivered to a target IO device in the IO node 124. Thereafter, the target IO device sends back reply data to the processor node 100 via the node control device 132 and the node control device 130.

### (2) Second Operation

A second operation is an operation of each node control device in which each input port handles a single IO space.

The processor node performs an initialization as follows:

The system firmware assigns the following address ranges of IO spaces to the IO nodes 120 through 127.

IO node 120: “0000” through “1 FFF” in hexadecimal notation

IO node 121: “2000” through “3FFF” in hexadecimal notation

IO node 122: “4000” through “5FFF” in hexadecimal notation

IO node 123: “6000” through “7FFF” in hexadecimal notation

IO node 124: “8000” through “9FFF” in hexadecimal notation

IO node 125: “A000” through “BFFF” in hexadecimal notation

IO node 126: “C000” through “DFFF” in hexadecimal notation

IO node 127: “E000” through “FFFF” in hexadecimal notation

The system firmware sets predetermined values to the tables 401 of the input ports 300 through 308 of the node control devices 130 through 133. Herein, the table 401 describes the memory space map “0” and the IO space number “000” in binary notation with respect to all of entries 0 through 7. In addition, the following values are set to the upper-limit address and the lower-limit address with respect to entries 0 through 7.

Entry 0: “000111” and “000000” in binary notation

Entry 1: “001111” and “001000” in binary notation

Entry 2: “010111” and “010000” in binary notation

Entry 3: “011111” and “011000” in binary notation

Entry 4: “100111” and “100000” in binary notation

Entry 5: “101111” and “101000” in binary notation

Entry 6: “110111” and “110000” in binary notation

Entry 7: “111111” and “111000” in binary notation

In this connection, a service processor can substitute for the system firmware so as to set up the above values.

Next, the processor node 100 performs an IO read operation on an IO device subordinate to the IO node 124 by use of an IO space address of “8000” in hexadecimal notation.

The processor node 100 issues an FRTT signal 330 having the header FRTT format of FIG. 7A, including a strobe of “01” in binary notation, an IO read command as a command code, a node ID of the processor node 100 as a source node ID, a node ID of the node control device 130 as a target node ID, and a length of accessed data as a data length. A transaction ID is set to a unique number with respect to the processor node 100. An address field of the header FRTT format of FIG. 7A is determined in accordance with the address format of FIG. 8A, in which bit 47 through bit 16 are all set to zeros, and bit 15 through bit 0 are set to “8000” in hexadecimal notation. That is, the processor node 100 issues an IO read code corresponding to an address of “000000008000” in hexadecimal notation.

Next, the operation of the IO space access detection circuit 402 using a single IO space will be described with reference to the flowchart of FIG. 9.

Upon receiving an FRTT signal 330 from the processor node 100, the IO space access detection circuit 402 checks the strobe field of “01” in binary notation so as to discriminate a header FRTT; subsequently, the IO space access detection circuit 402 compares the command code field and the address field with the value of the register 400 and the value of the table 401.

Specifically, the IO space access detection circuit 402 checks the command code field in step S1; subsequently, the IO space access detection circuit 402 detects an access to an IO space in accordance with an IO read code in step S2. The flow proceeds to step S5.

In step S5, the IO space access detection circuit 402 detects that the header FRTT describes the memory space map “0” and the address of bit 15 through bit IO retaining “100000” in binary notation which falls within the address range between the lower-limit address and the upper-limit address, i.e. “100000” through “100111” in binary notation, in connection with entry 4 of the table 401. Since the address agrees with the lower-limit address, the flow proceeds to step S7 in which the IO space access detection circuit 402 outputs the coincidence signal 412 of “1” and the node ID signal 413 describing the node ID of the IO node 214 corresponding to entry 4 of the table 401. Thereafter, the IO space access detection circuit 402 exits the procedure of FIG. 9.

Upon receiving the FRTT signal 330 having the header FRTT format from the processor node 100, the IO space access FRTT generation circuit 403 outputs a header FRTT signal 414 in which bit 47 through bit 32 of the address field are all set to zeros, and the target node ID is changed with the node ID signal 413 output from the IO space access detection circuit 402. In this connection, it can be said that no operation is needed to change digits of bit 47 through bit 32 of the address field because all digits are set to zeros before and after changes.

Upon receiving the coincidence signal 412 of “1”, the selector 404 selects the header FRTT signal 414 as the FRTT signal 340, which is output to the crossbar switch 320.

The crossbar switch 320 outputs FRTT data (corresponding to the FRTT signal 340) to the output port 317 in accordance with the target node ID. In this connection, the detailed method for determining a destination of an output port is irrelevant to the present embodiment; hence, an explanation thereof will be omitted.

The output port 317 sends FRTT data to the IO node 124 via the node control device 132, so that FRTT data is delivered to a target IO device in the IO node 124. Subsequently, the target IO device sends back replay data to the processor node 100 via the node control device 132 and the node control device 130.

The following description refers to a variation of the information processing system, the overall area of which is divided into two partitions, one of which uses a single IO space and the other of which uses a plurality of IO spaces mapped onto a memory space.

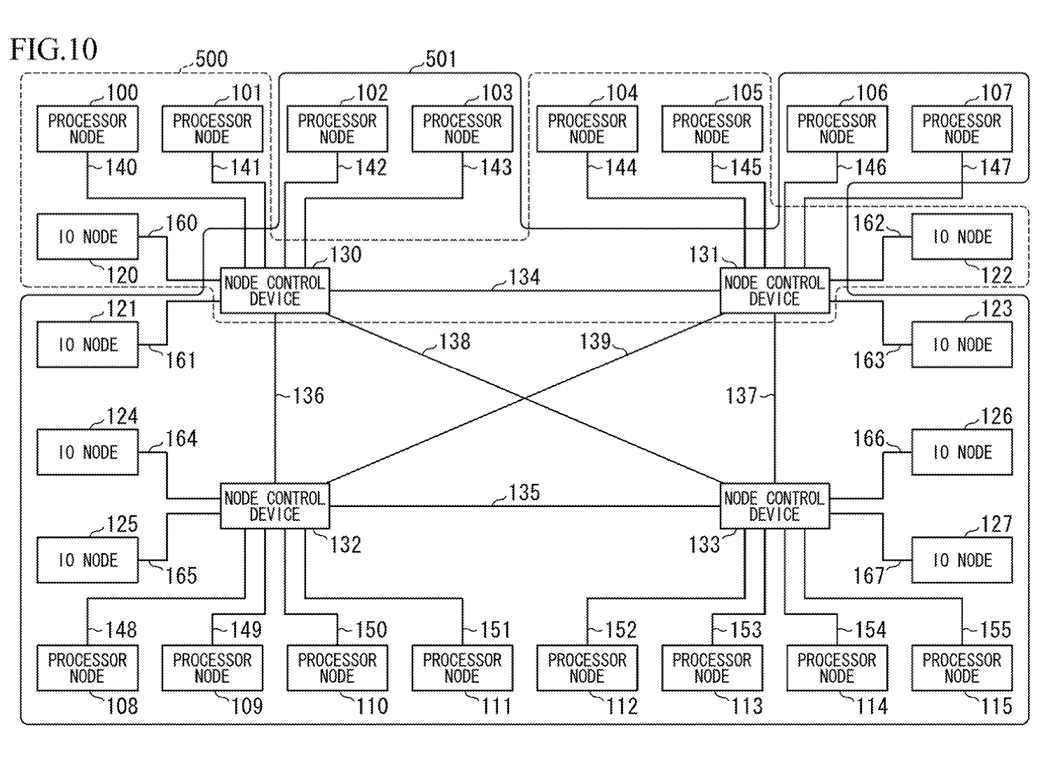

FIG. 10 is a block diagram of the information processing system divided into two partitions.

Specifically, the information processing system of FIG. 1 is divided into partitions 500 and 501, each of which is independently controlled by a unique operating system (OS). Herein, the partition 500 uses a single IO space while the partition 501 uses a plurality of IO spaces mapped onto a memory space.

Each processor node is initialized with respect to each partition independently. The node control devices 130 and 131 are shared by both the partitions 500 and 501, wherein the input ports 300 through 303 are each initialized in connection with the relevant partition(s).

The partition 500 includes the processor nodes 100, 101, 104, and 105; hence, the content of the table 401 is set up with respect to each of the input ports of the node control devices 130 and 131.

The partition 500 includes the IO nodes 120 and 122; hence, valid ranges are set to only the entries 0 and 2 of the table 401, while invalid ranges are set to other entries 1, and 3 through 7 corresponding to the other IO nodes which are not included in the partition 500. One example of an invalid range is defined between an upper-limit address of “000000” and a lower-limit address of “111111” in binary notation.

The partition 501 includes the processor nodes 102, 103, 106, 107, and 108 through 115; hence, the contents of the register 400 and the table 401 are set up with respect to each of the input ports 302 and 303 of the node control devices 130 and 131, as well as each of the input ports 300 through 303 of the node control devices 132 and 133.

The partition 501 includes the IO nodes 121, and 123 through 127; hence, valid ranges are set to entries 1 and 3 through 7 of the table 401, while invalid ranges are set to other entries 0 and 2 corresponding to other IO nodes which are not included in the partition 501. Detailed operations subsequent to initial setup are similar to those of the foregoing embodiment; hence, an explanation thereof will be omitted.

According to the information processing system of the present embodiment, the node control device has a function of mapping a plurality of IO spaces onto a memory space, so that it is able to recognize an IO space number upon detecting an access to a mapped IO space so as to precisely deliver FRTT data to a target IO node; this makes it possible to handle a plurality of IO spaces. Thus, the present embodiment demonstrates an outstanding effect of effectively using numerous IO devices in connection with a single processor node.

The present embodiment introduces an identification flag to discriminate a single IO space and an IO space which is assigned to a counterpart IO device and mapped onto a memory space. This scheme allows the conventional OS, which is unable to handle a plurality of IO spaces, to run without problem.

In addition, the present embodiment introduces a processing circuit which is dedicated to each of input ports included in each node control device and which can be set up independently. When the information processing system is divided into a plurality of partitions, it is possible to share different types of operating systems (OS), namely an OS supporting a plurality of IO spaces and an OS supporting a single IO space. That is, it is possible to arbitrary combine various operating systems on the information processing system.

At least a part of the processing of the node control device can be realized under control of a computer which is able to run a program implementing the procedure of FIG. 9. This program can be stored in and distributed via semiconductor memories and computer-readable storage media such as CD-ROM and magnetic tapes. The term “computer” embraces a microcomputer, a personal computer, and a general-purpose computer, each of which is able to execute the above program read from the above storage media.

The present invention is preferably applied to the architecture of the node control device and the information processing system in which each processor node needs to control numerous input/output devices by use of a large-scale storage space.

Lastly, the present invention is not necessarily limited to the embodiment, which can be further modified within the scope of the invention as defined in the appended claims.

What is claimed is:

1. A node control device adapted to an information processing system including a plurality of processor nodes and a plurality of IO nodes having IO spaces, each of which stores attribute information with respect to at least one IO device, said node control device being interposed between the processor node and the IO node comprising:
a table describing a plurality of entries retaining the attribute information with respect to the IO spaces in connection with the IO devices; and
an IO space access detection circuit that compares an instruction signal of the processor node with the attribute information of each of the entries described in the table so as to detect a designated IO node and a designated IO device.

2. The node control device according to claim 1, wherein when one of the entries of the table matches the instruction signal of the processor node, the IO space access detection circuit refers to the entry of the table so as to detect the designated IO node and the designated IO device, and wherein when none of the entries of the table matches the instruction signal of the processor node, the IO space access detection circuit detects the designated IO node and the designated IO device based on the instruction signal of the processor node.

3. The node control device according to claim 1, wherein each of the entries of the table includes information as to whether or not its counterpart IO space is mapped onto a memory space.

4. The node control device according to claim 1, wherein each of the entries of the table includes an IO space number, an upper-limit address and a lower-limit address of its counterpart IO space.

5. The node control device according to claim 1, wherein the instruction signal of the processor node is an FRTT signal having a header FRTT format including a command code, a target node ID, a source node ID, and an address, so that the IO space access detection circuit checks whether or not the address of the FRTT signal falls within an address range between an upper-limit address and a lower-limit address which are preset with respect to each of the entries of the table.

6. The node control device according to claim 5, wherein when one of the entries of the table matches the FRTT signal of the processor node, the target node ID of the FRTT signal is changed with the designated IO node detected by the IO space access detection circuit, thus outputting the changed FRTT signal to a crossbar switch establishing a connection between the designated IO device of the designated IO node and the processor node.

7. A node control method adapted to an information processing system including a plurality of processor nodes and a plurality of IO nodes having IO spaces, each of which stores attribute information with respect to at least one IO device, said node control method comprising:
describing a plurality of entries retaining the attribute information with respect to the IO spaces in connection with the IO devices in advance;
comparing an instruction signal of the processor node with the attribute information of each of the entries; and
detecting a designated IO node and a designated IO device based on the entry which matches the instruction signal of the processor node.

8. An information processing system comprising:
a plurality of processor nodes;
a plurality of IO nodes having IO spaces, each of which stores attribute information with respect to at least one IO device; and
a node control device interposed between the processor node and the IO node, including a table describing a plurality of entries retaining the attribute information with respect to the IO spaces in connection with the IO devices, and an IO space access detection circuit which compares an instruction signal of the processor node with the attribute information of each of the entries described in the table so as to detect a designated IO node and a designated IO device.

9. The information processing system according to claim 8, which is divided into a first partition handling a single IO space and a second partition handling a plurality of IO spaces.

10. A computer program causing a computer to execute a node control method adapted to an information processing system including a plurality of processor nodes and a plurality of IO nodes having IO spaces, each of which stores attribute information with respect to at least one IO device, said node control method comprising:
describing a plurality of entries retaining the attribute information with respect to the IO spaces in connection with the IO devices in advance;
comparing an instruction signal of the processor node with the attribute information of each of the entries; and
detecting a designated IO node and a designated IO device based on the entry which matches the instruction signal of the processor node.
